(19) United States
(12) Patent Application Publication
(10) Pub. No.: US 2025/0004851 A1
(43) Pub. Date: Jan. 2, 2025

(54) SYSTEM, METHOD AND APPARATUS FOR HARDWARE-BASED CORE PARKING USING WORKLOAD TELEMETRY INFORMATION

(71) Applicant: Intel Corporation, Santa Clara, CA (US)

(72) Inventors: Yevgeni Sabin, Haifa (IL); Madhusudan Chidambaram, Bangalore (IN); Refael Mizrahi, Raanana (IL); Efraim Rotem, Santa Clara, CA (US); Rajshree A. Chabukswar, Sunnyvale, CA (US); Eliezer Weissmann, Haifa (IL); Stephen H. Gunther, Beaverton, OR (US); Hisham Abu-Salah, Santa Clara, CA (US); Sneha Gohad, San Jose, CA (US); Anusha Ramachandran, Bengaluru (IN); Praveen Koduru, Bangalore (IN); Hadas Beja, Yehud (IL); Nofar Mani, Giv'atayim (IL); Hadar Ringel, Ramat Yishai (IL); Avishai Wagner, Santa Clara, CA (US)

(21) Appl. No.: 18/344,092

(22) Filed: Jun. 29, 2023

(51) Int. Cl. G06F 9/50; G06F 9/54

(52) U.S. Cl. CPC G06F 9/505; G06F 9/54

(57) ABSTRACT

In one embodiment, a processor includes: at least one first core to execute instructions; at least one second core to execute instructions; and a control circuit coupled to the at least one first core and the at least one second core. The control circuit may be configured to: receive workload telemetry information regarding a workload for execution on the processor; determine a QoS distribution based at least in part on the workload telemetry information; receive a predicted workload type, the predicted workload type based at least in part on the QoS distribution; and cause at least one of the at least one first core or the at least one second core to be parked based on the predicted workload type and the QoS distribution. Other embodiments are described and claimed.

### BACKGROUND

Modern processors can consume high amounts of power, which can impact battery life. Oftentimes, power control circuitry of a processor controls power consumption by reducing operating frequency and/or voltage. However doing so limits performance, which can be undesirable when a high performance workload is executing.

One technique to save power is to place one or more cores into a parked or low power state in which the cores are controlled to be inactive. In certain battery-powered scenarios, a fixed control is used to park a predetermined number of cores. This fixed enumeration does not account for runtime characteristics of workloads or the types of tasks in execution, and often can cause too many cores to remain unparked, which impacts power consumption.

### BRIEF DESCRIPTION OF THE DRAWINGS

FIG. 1 is a block diagram of a computing system in accordance with an embodiment.

FIG. 2 is a block diagram of a system on chip in accordance with an embodiment.

FIG. 3 is a flow diagram of a method in accordance with an embodiment.

FIG. 4 is a flow diagram of a method in accordance with another embodiment.

FIG. 5 is a block diagram of a processor in accordance with an embodiment.

FIG. 6 illustrates an example computing system.

FIG. 7 illustrates a block diagram of an example processor in accordance with an embodiment.

FIG. 8 is a block diagram of a processor core in accordance with an embodiment.

### DETAILED DESCRIPTION

In various embodiments, a processor having multiple cores can be manufactured with multiple different core types. These different core types may provide for a range of performance and power efficiency, as the different core types can have different micro-architectures and capabilities and operate at different power consumption levels.

In embodiments, various telemetry may be used to improve hardware-based core parking decisions. When a core is parked, it is identified to an operating system (OS) and/or other system software as being unavailable for scheduling. When open or unparked, a core is available for such scheduling. When one or more cores are parked, unparked cores may operate at higher frequencies (and thus with higher power consumption) since the unparked cores do not consume any substantial power.

In a particular embodiment, telemetry information used to make core parking decisions may include: per energy performance preference (EPP) and/or hardware power state (HWP) type central processing unit (CPU) usage information, including, for example, an indication of foreground or background activity, and other inputs (such as system software (e.g., operating system) inputs). This information may be used to drive workload classification to realize a power benefit for low usage foreground activity (low usage high quality of service (QOS)/EPP). In addition, concurrency/utilization information may be applied on top of a current workload classification to reduce a number of open cores in a burst scenario. For limited thread cases, if based on additional statistics it is determined that a lesser number of cores is needed, only this determined number of cores are to be kept open, enabling additional turbo frequency benefits.

Embodiments thus enhance performance in power constrained scenarios. Specifically, embodiments may be used to enhance performance on high core count processors in mixed workloads such as gaming or information technology (IT) build corporate systems, as well as battery-operated systems.

With embodiments, unimportant activity may be serialized on one or a limited set of cores, and not considering this activity in a workload classification. Embodiments may be particularly applicable to hybrid systems on chip (SoCs) that have heterogenous cores, including one or more low power domains and a chiplet design. In such implementations, significant power savings may be realized when work is maintained on a low power domain, saving the overhead of opening another chiplet or domain.

Embodiments may further enhance performance based at least in part on concurrency and utilization information. For example, without an embodiment when a workload is predicted as a burst type, all cores may remain open. Instead, with embodiments concurrency and utilization information may be added as an additional filter, to enable a limited set of cores to remain open when a workload demands lesser cores. Performance gains in this regard may be realized from extra turbo frequency bins becoming available when parking additional cores based on a given burst prediction. When a processor is executing mixed foreground/background (FG/BG) workloads, maintaining the BG workloads at low frequency (on one or more cores to execute serially) releases power budget for the FG workloads (that may execute on one or more other cores at higher frequencies).

In one or more embodiments, additional statistics used to drive decisions may include per EPP/HWP group detection. Stated another way, this group detection may be performed by establishing a plurality of EPP groups, and classifying each core into a given EPP group based on its EPP value. In an embodiment, EPP values may be in a nominal range of 0 to 100, where an EPP value of 0 expresses a highest preference for performance and an EPP value of 100 expresses a highest preference for energy savings.

In an example illustration, assume that 30% of present cores have a first EPP value (e.g., 25) and that 25% of present cores have a second EPP value (e.g., 50). With this information, it can be determined which EPP values are prominent so that they can be identified with high or low QoS workloads. With the above groupings, the high QoS is EPP 25, given that only two ranges are active. In turn, the utilization of the EPP 25 grouping can be used in combination with a determined workload type to determine a core parking mask that is used to identify which cores are to be placed into a parked state.

This per EPP type utilization information may be used to determine the workload classification. In turn, this workload classification may drive core parking decisions. It helps in scenarios such as when there is a small percentage of utilization from high QoS/foreground activity, but sustained background activity. In this case, the workload is not predicted as sustained, leaving fewer cores open which helps reduce power consumption (and improves power key performance indicators (KPIs)).

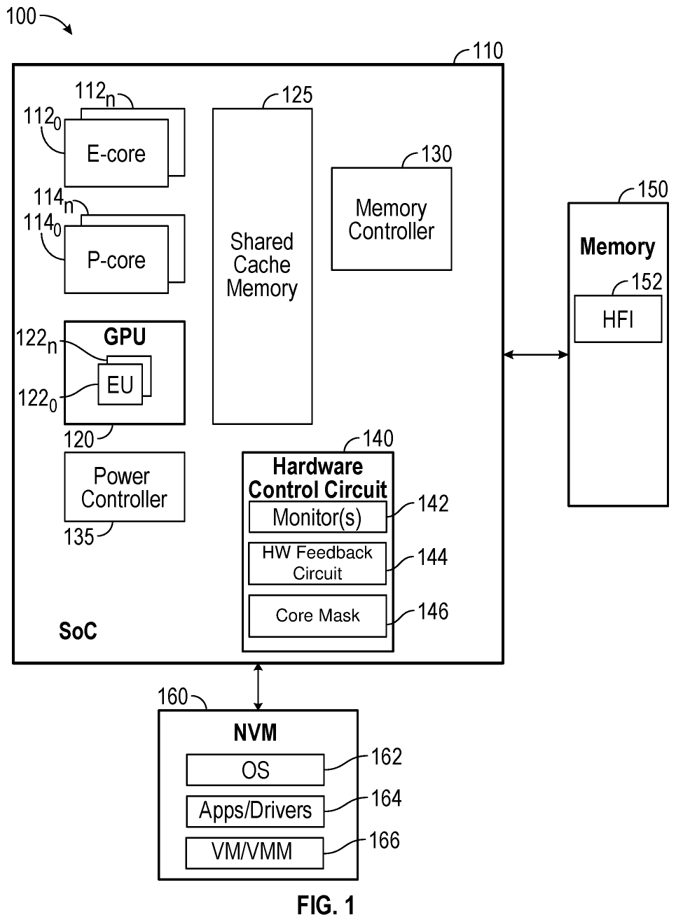

Referring now to FIG. 1, shown is a block diagram of a system in accordance with an embodiment. As shown in FIG. 1, computing system 100 may be any type of computing device, ranging from a relatively small device such as a smartphone to larger devices, including laptop computers, desktop computers, server computers or so forth. In the high level shown in FIG. 1, system 100 includes a processor that is implemented as an SoC 110, although other processor implementations are possible. As shown, processor SoC 110 couples to a memory 150 which is a system memory (e.g., a dynamic random access memory (DRAM)), and a non-volatile memory 160 which in different embodiments can be implemented as a flash memory, disk drive or so forth. Understand that the terms “system on chip” or “SoC” are to be broadly construed to mean an integrated circuit having one or more semiconductor dies implemented in a package, whether a single die, a plurality of dies on a common substrate, or a plurality of dies at least some of which are in stacked relation. Thus as used herein, such SoCs are contemplated to include separate chiplets, dielets, and/or tiles, and the terms “system in package” and “SiP” are interchangeable with system on chip and SoC.

With respect to SoC 110, included are a plurality of cores. In the particular embodiment shown, two different core types are present, namely first cores 112₀-112ₙ (so-called efficiency cores (E-cores)) and second cores 114₀₋ₙ (so-called performance cores (P-cores)). As further shown, SoC 110 includes a graphics processing unit (GPU) 120 including a plurality of execution units (EUs) 122₀₋ₙ. In one or more embodiments, first cores 112 and second cores 114 and/or GPU 120 may be implemented on separate dies.

These various computing elements couple to additional components of SoC 110, including a shared cache memory 125, which in an embodiment may be a last level cache (LLC) having a distributed architecture. In addition, a memory controller 130 is present along with a power controller 135, which may be implemented as a hardware control circuit that may be a dedicated microcontroller to execute instructions, e.g., stored on a non-transitory storage medium (e.g., firmware instructions). In other cases, power controller 135 may have different portions that are distributed across one or more of the available cores.

Still with reference to FIG. 1, SoC 110 further includes a hardware control circuit 140 independent of power controller 135. In various embodiments herein, hardware control circuit 140 may be configured to monitor operating conditions, e.g., using one or more monitors 142. Based at least in part on the monitored operating conditions, a hardware feedback circuit 144 of hardware control circuit 140 may maintain hardware feedback information, which may dynamically indicate processor capabilities, e.g., with respect to performance and efficiency, such as the EPP information discussed above. Hardware control circuit 140 may further make care parking decisions as described herein. In turn, hardware control circuit 140 may store an identification of parked/unparked cores in a core parking mask 146, which may be stored in a register or other storage of hardware control circuit 140 (or other location).

In one embodiment, hardware feedback circuit 144 may update information present in an interface structure stored in memory 150. Specifically, a hardware feedback interface (HFI) 152 may be stored in memory 150 that includes information regarding, inter alia, efficiency and performance levels of various cores, and optionally the parked state, e.g., as stored in core parking mask 146.

When this information is updated, hardware control circuit 140 may communicate, e.g., via an interrupt, to an OS 162. As illustrated, NVM 160 may store OS 162, various applications, drivers and other software (generally identified at 164), and one or more virtualization environments 166 (generally identified as VMM/VM 166). In one instantiation, communication of hardware feedback information to OS 162 may be via Intel® Thread Director technology, implemented at least in part in hardware feedback circuit 144.

Understand while shown at this high level in the embodiment of FIG. 1, many variations and alternatives are possible, and other implementations of SoC 100 can equally incorporate embodiments. For example depending on market segment, an SoC can include, instead of a hybrid product having heterogeneous core types, only cores of a single type. Further, more or different accelerator types may be present. For example, in addition to or instead of GPUs, an SoC may include a direct streaming accelerator (DSA), field programmable gate array (FPGA) or other accelerator.

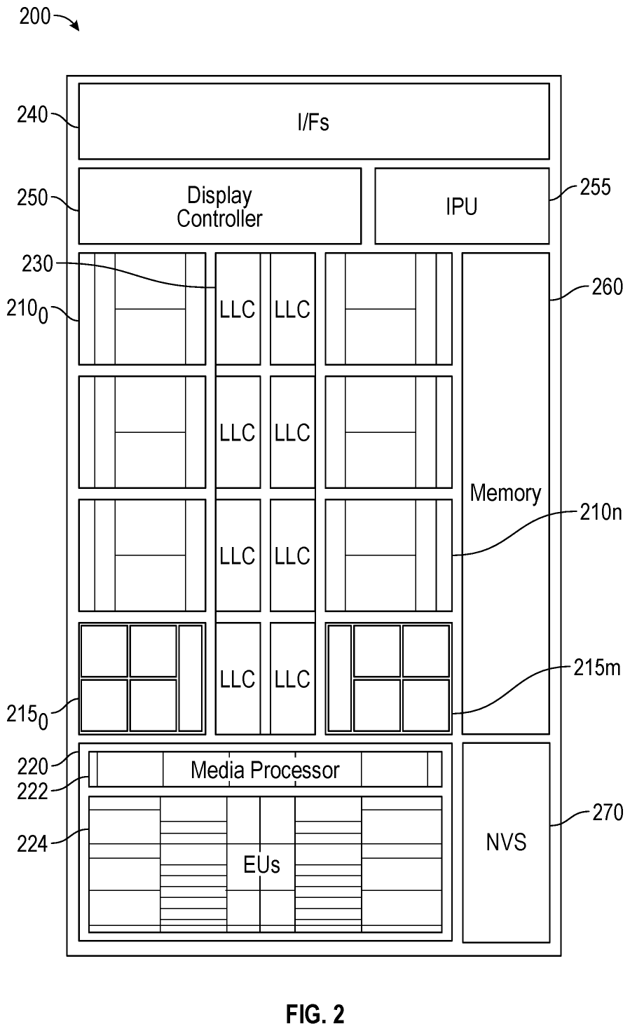

Referring now to FIG. 2, shown is a block diagram of an SoC in accordance with another embodiment. More specifically as shown in FIG. 2, SoC 200 is a multicore processor, including a first plurality of cores 210₀₋ₙ and a second plurality of cores 215₀₋ₘ. In one or more embodiments, first cores 210 may be implemented as performance cores, in that they may include greater amounts of circuitry (and wider and deeper pipelines) to perform more advanced computations in a performant manner. In contrast, second cores 215 may be configured as smaller cores that consume less power and may perform computations in a more efficient manner (e.g., with respect to power) than first cores 210. In certain implementations, first cores 210 may be referred to as P-cores (for performance cores) and second cores 215 may be referred to as E-cores (for efficiency cores). Note that different numbers of first and second cores may be present in different implementations.

As further illustrated in FIG. 2, a cache memory 230 may be implemented as a shared cache arranged in a distributed manner. In one or more embodiments, cache memory 230 may be a LLC having a distributed implementation in which one or more banks are associated with each of the cores.

As further illustrated, a GPU 220 may include a media processor 222 and a plurality of EUs 224. Graphics processor 220 may be configured for efficiently performing graphics or other operations that can be broken apart for execution on parallel processing units such as EUs 224.

Still referring to FIG. 2, various interface circuitry 240 is present to enable interface to other components of a system. Although embodiments are not limited in this regard, such interface circuitry may include a Peripheral Component Interconnect Express (PCIe) interface, one or more Thunderbolt™ interfaces, an Intel® Gaussian and Neural Accelerator (GNA) coprocessor and so forth. As further illustrated, processor 200 includes a display controller 250 and an image processing unit (IPU) 255.

As further shown, SoC 200 also includes a memory 260 that may provide memory controller functionality for interfacing with a system memory such as DRAM. Understand while shown at this high level in the embodiment of FIG. 2, many variations and alternatives are possible. Note that in this implementation, separate power controller circuitry such as power controller 135 and hardware control circuit 140 of FIG. 1 is not separately shown. Depending upon implementation such components may be separate circuits present within SoC 200 or this functionality may be performed by one or more of first and/or second cores or other processing unit.

With embodiments herein, SoC 200 may be configured to maintain, e.g., based on one or more environmental conditions such as power or thermal events, updated hardware feedback information regarding first cores 210 and second cores 215. In turn, control circuitry may, via an interface, inform the OS regarding this hardware feedback information, which may be used by the OS scheduler to schedule threads of given workloads to appropriate core types.

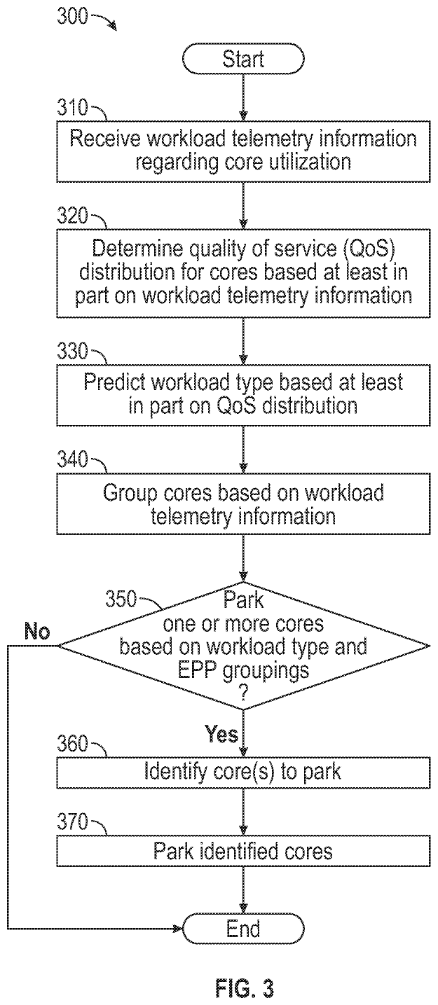

Referring now to FIG. 3, shown is a flow diagram of a method in accordance with an embodiment. As shown in FIG. 3, method 300 is a method for using workload telemetry information and EPP values and potentially parking one or more cores based on the updated EPP values. As such, method 300 may be performed by hardware circuitry such as may be implemented in a controller of a processor, alone and/or in combination with firmware and/or software.

As illustrated, method 300 begins by receiving workload telemetry information regarding core utilization (block 310). In an embodiment, control circuitry of a power controller may receive this workload telemetry information that includes EPP values. In this or other embodiments, additional telemetry information may include one or more of: SoC activity profile, runtime profiling, interrupts, use of particular compute blocks such as display hardware, use of hardware accelerators such as graphics processing unit (GPU), vision processing unit (VPU) or so forth. Additional telemetry information may be derived from device drivers, which can provide usage hints, implicitly or explicitly. The control circuitry may determine quality of service (QOS) metrics from such various telemetry information.

Still with reference to FIG. 3, next at block 320 a QoS distribution may be determined for the cores. More specifically, this QoS distribution may be based at least in part on the workload telemetry information. In an embodiment, this QoS distribution may be determined over a given unit of time, e.g., 200 microseconds. The QoS distribution may be determined based at least in part on counter-based information, as will be described further below. Next at block 330, a workload type may be predicted based at least in part on the determined QoS distribution. In an embodiment, this workload type prediction may be obtained from a machine learning (ML) engine such as an ML classifier. To this end, the controller may send information regarding the QoS distribution to the ML engine for its use in determining this prediction. In other cases, this prediction may be made within the controller itself.

Still with reference to FIG. 3, next at block 340 cores can be grouped based at least in part on the workload telemetry information (e.g., EPP values). For example, multiple groupings can be established, with each group representing a range of EPP values. Depending on implementation a full EPP range (e.g., 0-100) can be split into 3 to 10 groups, depending on desired granularity or so forth.

Further referring to FIG. 3, next at diamond 350 it may be determined whether one or more cores are to be parked based on workload type and EPP groupings. For example, when a workload is bursty or sustained, it may be appropriate to park one or more cores to allow the workload to be performed at higher frequencies (e.g., so-called turbo frequencies). This is the case, since additional power and thermal headrooms become available as fewer cores remain in an unparked state.

If it is determined that one or more cores are to be parked, control passes to block 360, where the cores to be parked are identified. In some implementations, this determination may be made based on a predetermined list of core preferences for parking. In other cases, depending upon the workload type, higher performant cores (e.g., P-cores) may be selected for parking instead of lower performant cores (e.g., E-cores). In any case, a core parking mask can be generated or updated based on this identification of cores to be parked. Finally, the identified core(s) may be parked (at block 370). To this end, a power controller may cause a core to become idle, e.g., by moving a currently executing workload to another core and/or removing a clock signal and/or voltage to the core. Understand while shown at this high level in the embodiment of FIG. 3, many variations and alternatives are possible.

Another option that can be used to identify QoS distributions is to monitor the active EPP group/utilization and then use only those active groups to determine which is high QoS (the lower EPP value group) and which is low QoS (higher EPP value group).

This second parameter from telemetry helps park extra cores for single-threaded or limited threaded scenarios (using concurrency/utilization along with workload classification) so that for a burst workload prediction, too many cores are not left open. This concurrency/usage information may be applied on top of workload predictions to dynamically adjust core counts for burst scenarios, so that limited threaded workloads can benefit from turbo frequency for performance KPIs.

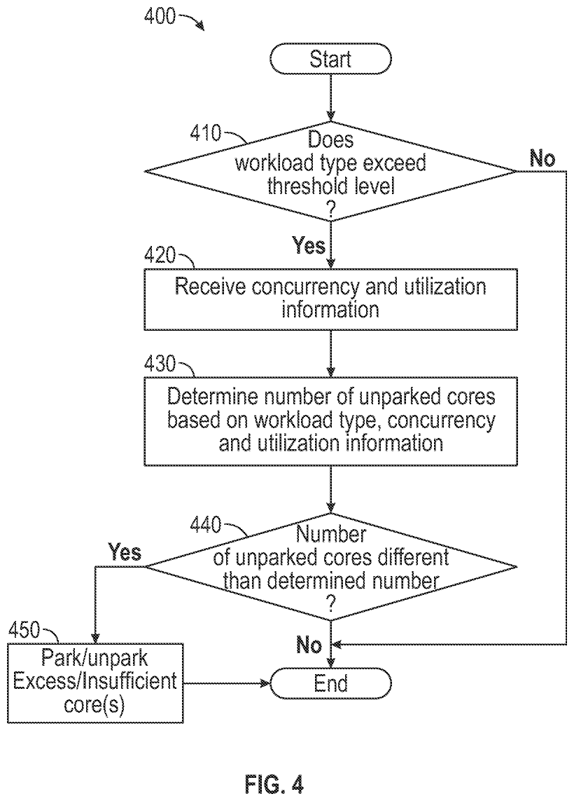

Referring now to FIG. 4, shown is a flow diagram of a method in accordance with another embodiment. More specifically, method 400 is a method for using additional telemetry information in guiding core parking decisions. As such, method 400 may be performed by hardware circuitry such as may be implemented in a general-purpose processor core, power controller, alone and/or in combination with firmware and/or software.

As illustrated, method 400 begins at diamond 410 by determining whether a workload type exceeds a threshold level. As an example, in an arrangement in which there are four workload types (e.g., bursty, sustained, background and battery life), the threshold level may be set at background. In this case, it may thus be determined at diamond 410 that the workload type exceeds the threshold level when the determined workload type is either bursty or sustained. When the workload type exceeds this threshold, control passes to block 420 where concurrency and utilization information may be received from the various cores. Control then passes to block 430, where the number of unparked cores is determined based on workload type as well as the received concurrency and utilization information. For example, following the above discussion from FIG. 3 the determination of the number of cores to keep unparked may be based on this further concurrency and utilization information.

Still referring to FIG. 4, control then passes to diamond 440 to determine whether the number of unparked cores that are currently parked is different than the determined number. If not, no further action occurs. Otherwise, control passes to block 450 where one or more cores may be parked to ensure that only the desired number of unparked cores remain unparked. Or if it is determined that a higher workload exists that requires additional cores, one or more cores may be unparked at block 450. Although shown at this high level in the embodiment of FIG. 4, many variations and alternatives are possible. Note that based on the concurrency information, background tasks can be scheduled to execute serially, e.g., on a single core operating at a lower frequency.

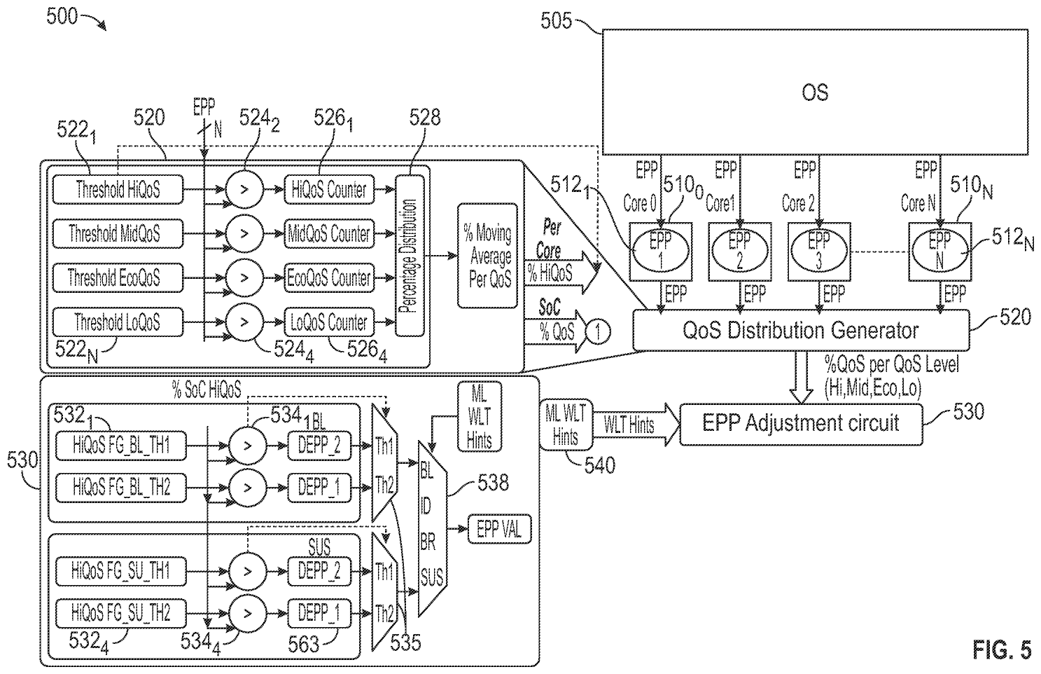

Referring now to FIG. 5, shown is a block diagram of a processor in accordance with an embodiment. As shown in FIG. 5, processor 500 is a multicore processor having a plurality of cores 510_{0-N}. Depending upon the implementation, cores 510 may be a set of homogenous cores. Or there can be heterogenous core types, e.g., including a mix of P-cores and E-cores. As shown, each core may have an associated EPP value setting 512₁-512_{N}. In general, these EPP values may be set by an OS 505. Although embodiments are not limited in this regard, OS 505 may provide EPP settings (e.g., via an EHFI structure) based on whether operation of a system including a processor is in an AC mode or DC (battery) mode. In other cases, OS 505 may provide EPP settings further based at least in part on OEM gear settings, an identification of whether given tasks are to execute on core foreground or background tasks or so forth.

Still with reference to FIG. 5, EPP values 512 are provided to a QoS distribution generator 520, which in one or more embodiments may be implemented with programmable control circuitry, either fully in hardware or with hardware that executes instructions stored in a non-transitory storage medium. As shown in the inset in FIG. 5, QoS distribution generator 520 is configured to determine a distribution of QoS levels for a workload being executed on processor 500. At a given interval, EPP values for the corresponding cores are provided to a set of comparators 524₁₋₄, where the EPP value for each core is compared to a threshold QoS level 522₁₋₄. As shown, there are four (e.g., configurable) QoS thresholds, including high, mid, eco and low; of course in other implementations there may be more or fewer threshold levels.

When, for a given unit interval (e.g., 1 millisecond), a given core's EPP value exceeds one of the thresholds, a corresponding comparator 524 issues a valid signal that is provided to a corresponding counter 526₁₋₄, which increments its count for the associated core. In an embodiment, counters 526 are configured to count the number of times one of the QoS levels is hit for every unit interval.

At the end of a longer interval (e.g., 200 milliseconds), percentage distribution generator 528 generates a distribution of the QoS levels for the workload executed on processor 500 as a moving average, e.g., an exponentially weighted moving average. In addition, for each core a percentage for which it is executing high QoS workloads is output. The percentage distribution can be computed on a per core basis.

This information is provided to an EPP adjustment circuit 530. As also shown, EPP adjustment circuit 530 receives workload type hints from a machine learning engine 540. As described herein, ML engine 540 may provide workload type hints that are based on the workload telemetry information (EPP value/QoS information itself).

Based on this information (workload type and per core percentage of high QoS distribution), EPP adjustment circuit 530 may, for high QoS workloads, cause an EPP adjustment for cores on which such high QoS workloads execute. For example, EPP values may be adjusted in a direction towards a lower EPP value, indicating a greater preference for performance. In one or more embodiments, EPP adjustment circuit 530 may be implemented with programmable control circuitry, either fully in hardware or with hardware that executes instructions stored in a non-transitory storage medium.

As shown in the inset in FIG. 5, EPP adjustment circuit 530 is configured to update an EPP value for a core based on determined QoS distributions for the core. At a given interval, QoS percentages from QoS distribution generator 520 is provided to a set of comparators 534₁₋₄, where these distributions are compared to a threshold high QOS foreground level 532₁₋₄ (for battery life and sustained workloads). Based on the comparisons, potential EPP updates for certain workloads are passed through a set of multiplexers 535 (where the output is selected based on the percentage of high QoS for the core). In turn, in another multiplexer 538, a given one of the updated EPP values can be output, based on the workload type hint from ML engine 540. Note that such EPP updates may be made for cores that are executing high QoS workloads. Although shown at this high level in the embodiment of FIG. 5, many variations and alternatives are possible.

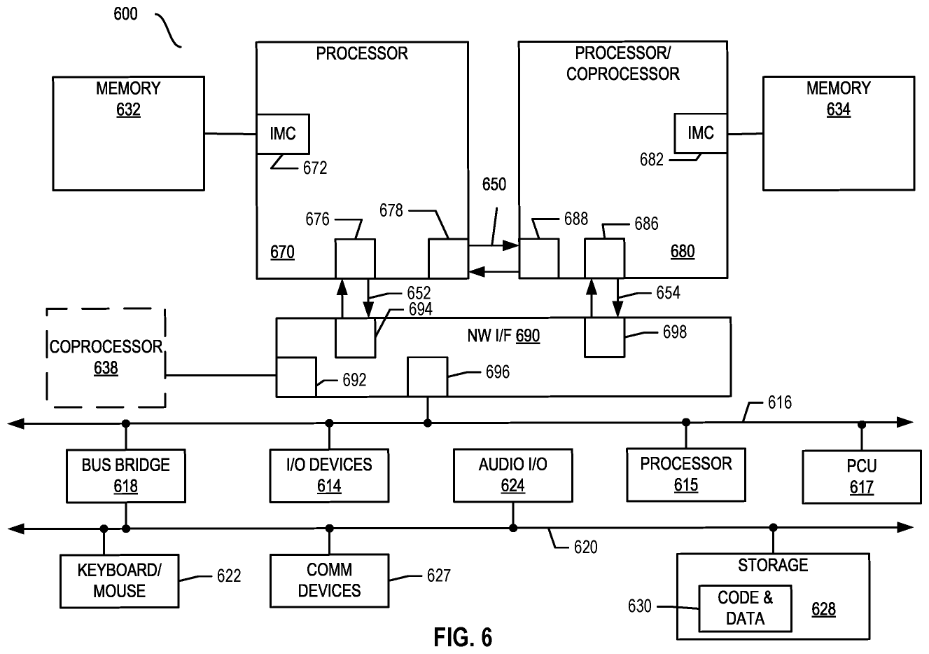

FIG. 6 illustrates an example computing system. Multiprocessor system 600 is an interfaced system and includes a plurality of processors or cores including a first processor 670 and a second processor 680 coupled via an interface 650 such as a point-to-point (P-P) interconnect, a fabric, and/or bus. In some examples, the first processor 670 and the second processor 680 are homogeneous. In some examples, first processor 670 and the second processor 680 are heterogenous. Though the example system 600 is shown to have two processors, the system may have three or more processors, or may be a single processor system. In some examples, the computing system is a SoC.

Processors 670 and 680 are shown including integrated memory controller (IMC) circuitry 672 and 682, respectively. Processor 670 also includes interface circuits 676 and 678; similarly, second processor 680 includes interface circuits 686 and 688. Processors 670, 680 may exchange information via the interface 650 using interface circuits 678, 688. IMCs 672 and 682 couple the processors 670, 680 to respective memories, namely a memory 632 and a memory 634, which may be portions of main memory locally attached to the respective processors.

Processors 670, 680 may each exchange information with a network interface (NW I/F) 690 via individual interfaces 652, 654 using interface circuits 676, 694, 686, 698. The network interface 690 (e.g., one or more of an interconnect, bus, and/or fabric, and in some examples is a chipset) may optionally exchange information with a coprocessor 638 via an interface circuit 692. In some examples, the coprocessor 638 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 670, 680 or outside of both processors, yet connected with the processors via an interface such as P-P interconnect, such that either or both processors' local cache information may be stored in the shared cache if a processor is placed into a low power mode.

Network interface 690 may be coupled to a first interface 616 via interface circuit 696. In some examples, first interface 616 may be an interface such as a Peripheral Component Interconnect (PCI) interconnect, a PCI Express interconnect or another I/O interconnect. In some examples, first interface 616 is coupled to a power control unit (PCU) 617, which may include circuitry, software, and/or firmware to perform power management operations with regard to the processors 670, 680 and/or co-processor 638. PCU 617 provides control information to a voltage regulator (not shown) to cause the voltage regulator to generate the appropriate regulated voltage. PCU 617 also provides control information to control the operating voltage generated. In various examples, PCU 617 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 617 is illustrated as being present as logic separate from the processor 670 and/or processor 680. In other cases, PCU 617 may execute on a given one or more of cores (not shown) of processor 670 or 680. In some cases, PCU 617 may be implemented as a microcontroller (dedicated or general-purpose) or other control logic configured to execute its own dedicated power management code, sometimes referred to as P-code. In yet other examples, power management operations to be performed by PCU 617 may be implemented externally to a processor, such as by way of a separate power management integrated circuit (PMIC) or another component external to the processor. In yet other examples, power management operations to be performed by PCU 617 may be implemented within BIOS or other system software. PCU 617 may be configured to make core parking decisions based at least in part on workload telemetry information as described herein.

Various I/O devices 614 may be coupled to first interface 616, along with a bus bridge 618 which couples first interface 616 to a second interface 620. In some examples, one or more additional processor(s) 615, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 616. In some examples, second interface 620 may be a low pin count (LPC) interface. Various devices may be coupled to second interface 620 including, for example, a keyboard and/or mouse 622, communication devices 627 and storage circuitry 628. Storage circuitry 628 may be one or more non-transitory machine-readable storage media as described below, such as a disk drive or other mass storage device which may include instructions/code and data 630. Further, an audio I/O 624 may be coupled to second interface 620. Note that other architectures than the point-to-point architecture described above are possible. For example, instead of the point-to-point architecture, a system such as multiprocessor system 600 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

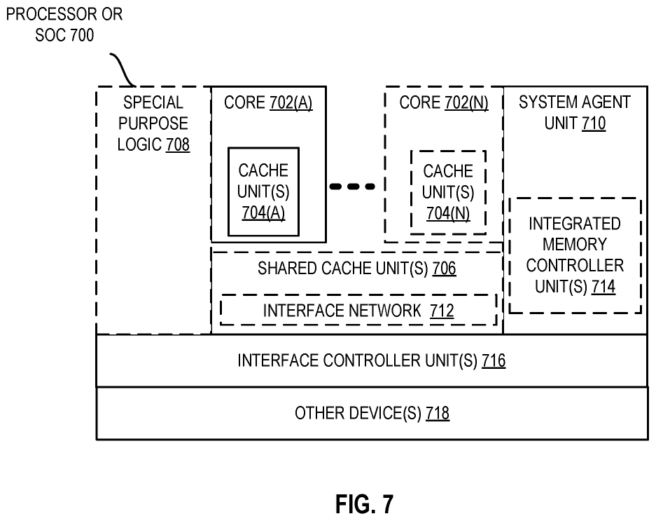

FIG. 7 illustrates a block diagram of an example processor and/or SoC 700 that may have one or more cores and an integrated memory controller. The solid lined boxes illustrate a processor 700 with a single core 702(A), system agent unit circuitry 710, and a set of one or more interface controller unit(s) circuitry 716, while the optional addition of the dashed lined boxes illustrates an alternative processor 700 with multiple cores 702(A)-(N), a set of one or more integrated memory controller unit(s) circuitry 714 in the system agent unit circuitry 710, and special purpose logic 708, as well as a set of one or more interface controller units circuitry 716. Note that the processor 700 may be one of the processors 670 or 680, or co-processor 638 or 615 of FIG. 6.

Thus, different implementations of the processor 700 may include: 1) a CPU with the special purpose logic 708 being integrated graphics and/or scientific (throughput) logic (which may include one or more cores, not shown), and the cores 702(A)-(N) being one or more general purpose cores (e.g., general purpose in-order cores, general purpose out-of-order cores, or a combination of the two); 2) a coprocessor with the cores 702(A)-(N) being a large number of special purpose cores intended primarily for graphics and/or scientific (throughput); and 3) a coprocessor with the cores 702(A)-(N) being a large number of general purpose in-order cores. Thus, the processor 700 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 700 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 704(A)-(N) within the cores 702(A)-(N), a set of one or more shared cache unit(s) circuitry 706, and external memory (not shown) coupled to the set of integrated memory controller unit(s) circuitry 714. The set of one or more shared cache unit(s) circuitry 706 may include one or more mid-level caches, such as level 2 (L2), level 3 (L3), level 4 (L4), or other levels of cache, such as a last level cache (LLC), and/or combinations thereof. While in some examples interface network circuitry 712 (e.g., a ring interconnect) interfaces the special purpose logic 708 (e.g., integrated graphics logic), the set of shared cache unit(s) circuitry 706, and the system agent unit circuitry 710, alternative examples use any number of well-known techniques for interfacing such units. In some examples, coherency is maintained between one or more of the shared cache unit(s) circuitry 706 and cores 702(A)-(N). In some examples, interface controller units circuitry 716 couple the cores 702 to one or more other devices 718 such as one or more I/O devices, storage, one or more communication devices (e.g., wireless networking, wired networking, etc.), etc.

In some examples, one or more of the cores 702(A)-(N) are capable of multi-threading. The system agent unit circuitry 710 includes those components coordinating and operating cores 702(A)-(N). The system agent unit circuitry 710 may include, for example, power control unit (PCU) circuitry and/or display unit circuitry (not shown). The PCU may be or may include logic and components needed for regulating the power state of the cores 702(A)-(N) and/or the special purpose logic 708 (e.g., integrated graphics logic), including making core parking decisions based at least in part on workload telemetry information as described herein. The display unit circuitry is for driving one or more externally connected displays.

The cores 702(A)-(N) may be homogenous in terms of instruction set architecture (ISA). Alternatively, the cores 702(A)-(N) may be heterogeneous in terms of ISA; that is, a subset of the cores 702(A)-(N) may be capable of executing an ISA, while other cores may be capable of executing only a subset of that ISA or another ISA.

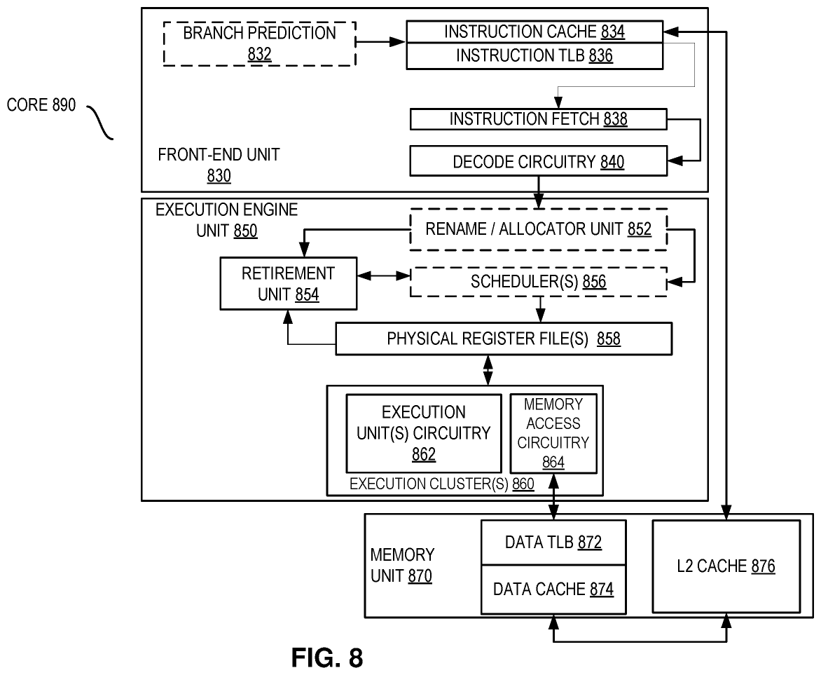

FIG. 8 shows a processor core 890 including front-end unit circuitry 830 coupled to execution engine unit circuitry 850, and both are coupled to memory unit circuitry 870. The core 890 may be a reduced instruction set architecture computing (RISC) core, a complex instruction set architecture computing (CISC) core, a very long instruction word (VLIW) core, or a hybrid or alternative core type. As yet another option, the core 890 may be a special-purpose core, such as, for example, a network or communication core, compression engine, coprocessor core, general purpose computing graphics processing unit (GPGPU) core, graphics core, or the like.

The front-end unit circuitry 830 may include branch prediction circuitry 832 coupled to instruction cache circuitry 834, which is coupled to an instruction translation lookaside buffer (TLB) 836, which is coupled to instruction fetch circuitry 838, which is coupled to decode circuitry 840. In one example, the instruction cache circuitry 834 is included in the memory unit circuitry 870 rather than the front-end circuitry 830. The decode circuitry 840 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 840 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 840 may be implemented using various different mechanisms. Examples of suitable mechanisms include, but are not limited to, look-up tables, hardware implementations, programmable logic arrays (PLAs), microcode read only memories (ROMs), etc. In one example, the core 890 includes a microcode ROM (not shown) or other medium that stores microcode for certain macroinstructions (e.g., in decode circuitry 840 or otherwise within the front-end circuitry 830). In one example, the decode circuitry 840 includes a micro-operation (micro-op) or operation cache (not shown) to hold/cache decoded operations, micro-tags, or micro-operations generated during the decode or other stages of the processor pipeline 800. The decode circuitry 840 may be coupled to rename/allocator unit circuitry 852 in the execution engine circuitry 850.

The execution engine circuitry 850 includes the rename/allocator unit circuitry 852 coupled to retirement unit circuitry 854 and a set of one or more scheduler(s) circuitry 856. The scheduler(s) circuitry 856 represents any number of different schedulers, including reservations stations, central instruction window, etc. In some examples, the scheduler(s) circuitry 856 can include arithmetic logic unit (ALU) scheduler/scheduling circuitry, ALU queues, address generation unit (AGU) scheduler/scheduling circuitry, AGU queues, etc. The scheduler(s) circuitry 856 is coupled to the physical register file(s) circuitry 858. Each of the physical register file(s) circuitry 858 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 858 includes vector registers unit circuitry, writemask registers unit circuitry, and scalar register unit circuitry. These register units may provide architectural vector registers, vector mask registers, general-purpose registers, etc. The physical register file(s) circuitry 858 is coupled to the retirement unit circuitry 854 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 854 and the physical register file(s) circuitry 858 are coupled to the execution cluster(s) 860. The execution cluster(s) 860 includes a set of one or more execution unit(s) circuitry 862 and a set of one or more memory access circuitry 864. The execution unit(s) circuitry 862 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 856, physical register file(s) circuitry 858, and execution cluster(s) 860 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster- and in the case of a separate memory access pipeline, certain examples are implemented in which only the execution cluster of this pipeline has the memory access unit(s) circuitry 864). It should also be understood that where separate pipelines are used, one or more of these pipelines may be out-of-order issue/execution and the rest in-order.

In some examples, the execution engine unit circuitry 850 may perform load store unit (LSU) address/data pipelining to an Advanced Microcontroller Bus (AMB) interface (not shown), and address phase and writeback, data phase load, store, and branches.

The set of memory access circuitry 864 is coupled to the memory unit circuitry 870, which includes data TLB circuitry 872 coupled to data cache circuitry 874 coupled to level 2 (L2) cache circuitry 876. In one example, the memory access circuitry 864 may include load unit circuitry, store address unit circuitry, and store data unit circuitry, each of which is coupled to the data TLB circuitry 872 in the memory unit circuitry 870. The instruction cache circuitry 834 is further coupled to the level 2 (L2) cache circuitry 876 in the memory unit circuitry 870. In one example, the instruction cache 834 and the data cache 874 are combined into a single instruction and data cache (not shown) in L2 cache circuitry 876, level 3 (L3) cache circuitry (not shown), and/or main memory. The L2 cache circuitry 876 is coupled to one or more other levels of cache and eventually to a main memory.

The following examples pertain to further embodiments.

In one example, a processor includes: at least one first core to execute instructions; at least one second core to execute instructions, the at least one second core heterogenous from the at least one first core; and a control circuit coupled to the at least one first core and the at least one second core. The control circuit may be configured to: receive workload telemetry information regarding a workload for execution on the processor; determine a QoS distribution based at least in part on the workload telemetry information; receive a predicted workload type, the predicted workload type based at least in part on the QoS distribution; and cause at least one of the at least one first core or the at least one second core to be parked based on the predicted workload type and the QoS distribution.

In an example, the control circuit is to receive the workload telemetry information comprising at least one EPP value associated with a first core of the at least one first core.

In an example, the control circuit is to group a plurality of cores comprising the at least one first core and the at least one second core into a plurality of core groups based at least in part on the EPP value.

In an example, the control circuit is to: determine the QoS distribution based on the plurality of core groups; and identify a group of the plurality of core groups having a largest number of cores.

In an example, the control circuit is to select at least one core to be parked based on the identity of the group of the plurality of core groups having the largest number of cores.

In an example, the control circuit is to set a parked core mask to identify the at least one core to be parked.

In an example, the control circuit is to communicate the parked core mask to a scheduler to prevent scheduling of tasks to the at least one core to be parked.

In an example, the control circuit is to receive the predicted workload type from a machine learning engine.

In an example, the control circuit is to: cause a first number of cores to be parked when the workload type is greater than a threshold workload type; and cause a second number of cores to be parked when the workload type is less than the threshold workload type, the second number of cores less than the first number of cores.

In an example, after the at least one of the at least one first core or the at least one second core is parked, the processor is to serialize execution of a plurality of background threads on an unparked one of the at least one first core or the at least one second core.

In another example, a method comprises: determining that a workload type for a workload to be executed on the processor exceeds a threshold level; receiving concurrency information regarding a number of cores of the processor in concurrent execution; increasing a number of parked cores of the processor based at least in part on the concurrency information; and causing a plurality of background tasks to be executed serially on at least one core of the processor.

In an example, the method further comprises determining that the workload type exceeds the threshold level when the workload type comprises a bursty workload or a sustained workload.

In an example, the method further comprises receiving the workload type from a machine learning engine.

In an example, the method further comprises communicating an indication of the increased number of parked cores to be accessible by an operating system.

In an example, the method further comprises communicating updated energy performance preference information with a hardware feedback interface based at least in part on the increased number of parked cores, the hardware feedback interface accessible to the operating system.

In an example, the method further comprises causing one or more foreground tasks to be executed at a turbo mode frequency on at least one other core of the processor.

In an example, the method further comprises updating a core parking mask to increase the number of parked cores of the processor.

In another example, a computer readable medium including instructions is to perform the method of any of the above examples.

In a further example, a computer readable medium including data is to be used by at least one machine to fabricate at least one integrated circuit to perform the method of any one of the above examples.

In a still further example, an apparatus comprises means for performing the method of any one of the above examples.

In another example, a system includes a processor and a memory coupled to the processor, the memory to store a hardware feedback interface. The processor comprises: a plurality of cores to execute instructions; storage coupled to the plurality of cores, the storage to store a core parking mask to identify one or more of the plurality of cores to be in a parked state; and a control circuit coupled to the plurality of cores. The control circuit may be configured to: receive EPP information for the plurality of cores; determine a QoS distribution based at least in part on the EPP information, the QoS distribution comprising a plurality of core groups, each of the plurality of core groups associated with an EPP level; and when a workload type is one of a predetermined set of workload types and core group having a highest number of cores is associated with an EPP level that indicates a performance preference, identify at least one core to park and update the core parking mask based on the identification of the at least one core to park.

In an example, the control circuit is to obtain the EPP information from the hardware feedback interface, and update at least some of the EPP information in the hardware feedback interface based on the identification of the at least one core to park.

In an example, when the workload type is a bursty workload or a sustained workload, the control circuit is to: identify a plurality of cores to park; cause one or more foreground tasks to execute at a turbo mode frequency on one or more cores of the processor; and cause a plurality of background tasks to execute serially on another core of the processor.

Understand that various combinations of the above examples are possible.

Note that the terms “circuit” and “circuitry” are used interchangeably herein. As used herein, these terms and the term “logic” are used to refer to alone or in any combination, analog circuitry, digital circuitry, hard wired circuitry, programmable circuitry, processor circuitry, microcontroller circuitry, hardware logic circuitry, state machine circuitry and/or any other type of physical hardware component. Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. Still further embodiments may be implemented in a computer readable storage medium including information that, when manufactured into a SOC or other processor, is to configure the SOC or other processor to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A processor comprising:
at least one first core to execute instructions;
at least one second core to execute instructions, the at least one second core heterogenous from the at least one first core; and
a control circuit coupled to the at least one first core and the at least one second core, wherein the control circuit is to:
receive workload telemetry information regarding a workload for execution on the processor;
determine a quality of service (QOS) distribution based at least in part on the workload telemetry information;
receive a predicted workload type, the predicted workload type based at least in part on the QoS distribution; and
cause at least one of the at least one first core or the at least one second core to be parked based on the predicted workload type and the QoS distribution.

2. The processor of claim 1, wherein the control circuit is to receive the workload telemetry information comprising at least one energy performance preference (EPP) value associated with a first core of the at least one first core.

3. The processor of claim 2, wherein the control circuit is to group a plurality of cores comprising the at least one first core and the at least one second core into a plurality of core groups based at least in part on the EPP value.

4. The processor of claim 3, wherein the control circuit is to:
determine the QoS distribution based on the plurality of core groups; and
identify a group of the plurality of core groups having a largest number of cores.

5. The processor of claim 4, wherein the control circuit is to select at least one core to be parked based on the identity of the group of the plurality of core groups having the largest number of cores.

6. The processor of claim 5, wherein the control circuit is to set a parked core mask to identify the at least one core to be parked.

7. The processor of claim 6, wherein the control circuit is to communicate the parked core mask to a scheduler to prevent scheduling of tasks to the at least one core to be parked.

8. The processor of claim 1, wherein the control circuit is to receive the predicted workload type from a machine learning engine.

9. The processor of claim 1, wherein the control circuit is to:
cause a first number of cores to be parked when the workload type is greater than a threshold workload type; and
cause a second number of cores to be parked when the workload type is less than the threshold workload type, the second number of cores less than the first number of cores.

10. The processor of claim 1, wherein after the at least one of the at least one first core or the at least one second core is parked, the processor is to serialize execution of a plurality of background threads on an unparked one of the at least one first core or the at least one second core.

11. At least one computer readable medium comprising instructions that, when executed by a processor, cause the processor to perform a method comprising:
determining that a workload type for a workload to be executed on the processor exceeds a threshold level;
receiving concurrency information regarding a number of cores of the processor in concurrent execution;
increasing a number of parked cores of the processor based at least in part on the concurrency information; and
causing a plurality of background tasks to be executed serially on at least one core of the processor.

12. The at least one computer readable medium of claim 11, wherein the method further comprises determining that the workload type exceeds the threshold level when the workload type comprises a bursty workload or a sustained workload.

13. The at least one computer readable medium of claim 11, wherein the method further comprises receiving the workload type from a machine learning engine.

14. The at least one computer readable medium of claim 11, wherein the method further comprises communicating an indication of the increased number of parked cores to be accessible by an operating system.

15. The at least one computer readable medium of claim 14, wherein the method further comprises communicating updated energy performance preference information with a hardware feedback interface based at least in part on the increased number of parked cores, the hardware feedback interface accessible to the operating system.

16. The at least one computer readable medium of claim 11, wherein the method further comprises causing one or more foreground tasks to be executed at a turbo mode frequency on at least one other core of the processor.

17. The at least one computer readable medium of claim 11, wherein the method further comprises updating a core parking mask to increase the number of parked cores of the processor.

18. A system comprising:
a processor comprising:
a plurality of cores to execute instructions;
storage coupled to the plurality of cores, the storage to store a core parking mask to identify one or more of the plurality of cores to be in a parked state; and
a control circuit coupled to the plurality of cores, wherein the control circuit is to:
receive energy performance preference (EPP) information for the plurality of cores;
determine a quality of service (QOS) distribution based at least in part on the EPP information, the QoS distribution comprising a plurality of core groups, each of the plurality of core groups associated with an EPP level; and
when a workload type is one of a predetermined set of workload types and core group having a highest number of cores is associated with an EPP level that indicates a performance preference, identify at least one core to park and update the core parking mask based on the identification of the at least one core to park; and
a memory coupled to the processor, the memory to store a hardware feedback interface.

19. The system of claim 18, wherein the control circuit is to obtain the EPP information from the hardware feedback interface, and update at least some of the EPP information in the hardware feedback interface based on the identification of the at least one core to park.

20. The system of claim 18, wherein when the workload type is a bursty workload or a sustained workload, the control circuit is to:
identify a plurality of cores to park;
cause one or more foreground tasks to execute at a turbo mode frequency on one or more cores of the processor; and
cause a plurality of background tasks to execute serially on another core of the processor.
